(19) United States
(12) Patent Application Publication
(10) Pub. No.: US 2025/0234995 A1
(43) Pub. Date: Jul. 24, 2025

(54) DRAWER ANTI-TIP DEVICE

(71) Applicant: TITUS D.O.O. DEKANI, Dekani (SI)

(72) Inventor: David PECAR, Dekani (SI)

(73) Assignee: TITUS D.O.O. DEKANI, Dekani (SI)

(21) Appl. No.: 19/026,222

(22) Filed: Jan. 16, 2025

(30) Foreign Application Priority Data
Jan. 19, 2024 (GB) 2400734.6

(51) Int. Cl. A47B 88/437; A47B 88/477

(52) U.S. Cl. CPC A47B 88/437; A47B 88/477

(57) ABSTRACT

A drawer unit including at least two drawers, each drawer having respective drawer runners to allow each drawer to move with respect to the drawer unit. The drawer unit further includes a drawer lock mechanism to permit the opening of a single drawer at a time. The lock mechanism includes a cam unit incorporating at least a cam lever, and a cam follower including a surface operable to engage with said cam lever associated with each drawer. The cam lever is operable to be rotated by action of the opening of its respective drawer, and engage with said cam follower, wherein movement of the cam follower and/or the cam unit causes compression of one or more compression means, and wherein the surface of the cam follower operable to engage with said cam lever is slanted when the drawer unit is in standard orientation at an angle of 15° to 25°.

### BACKGROUND

It is desirable to provide a drawer unit that includes a reliable anti-tip mechanism. It is desirable to provide a drawer unit that affords a smooth opening without requiring significant force from a user. It is particularly desirable to provide a mechanism that rapidly blocks a second drawer from opening to ensure the fingers of a user, and particularly the fingers of a child, are not trapped between the drawers.

U.S. Pat. No. 10,145,149 shows an example of an anti-tip mechanism. This drawer unit provides drawers that require significant force to begin opening of a drawer. Furthermore, this solution does not block the second drawer from being opened quickly, so the above problems still arise.

### DISCLOSURE OF THE INVENTION

According to the present invention there is provided a drawer unit comprising at least two drawers, each drawer comprising respective drawer runners to allow each drawer to move with respect to the drawer unit so as to open and close, the drawer unit further comprising a drawer lock mechanism to permit the opening of a single drawer at a time in said drawer unit, said lock mechanism comprising a cam unit incorporating at least a cam lever, and a cam follower comprising a surface operable to engage with said cam lever associated with each drawer, wherein the cam lever is operable to be rotated by action of the opening of its respective drawer, and engage with said cam follower, wherein movement of the cam follower and/or the cam unit causes compression of one or more compression means, and wherein the surface of the cam follower operable to engage with said cam lever is slanted when the drawer unit is in standard orientation at an angle of 15° to 25°.

By providing a cam follower with a camming surface slanted at an angle of 15° to 25°, the drawer is made easy for a user to open in the first instance and increases the force on the cam follower as the drawer opens. Such an arrangement also aids in rapidly stops the ability of a second drawer being opened. In the prior art arrangement—U.S. Pat. No. 10,145,149—there is a high initial slope on the cam follower which requires a high initial force to rotate the cam lever, thus requiring significant force on the part of the user to initially open the drawer.

It is preferred that the cam lever comprises a slider operable to reciprocally move substantially within the cam lever, a first end of the slider engaging said cam follower.

Preferably, the cam unit comprises a cam base, with said cam lever being rotatably mounted thereon. In particularly preferred arrangements, the cam unit comprises a cam surface operable to engage with a second end of said slider.

It is preferred that the cam surface has a continuously increasing eccentricity for at least a significant section thereof. The prior art does not provide a cam surface with an increasing eccentric surface, and hence the second drawer is not immediately blocked form opening.

Preferably, the cam surface has a first portion with a continuously increasing eccentricity and a second portion with a continuously decreasing eccentricity. Such an arrangement is advantageous in that the force required to open the drawer does not keep increasing. Once the slider reaches the decreasing eccentricity portion, the effect required by the user gradually decreases.

It is particularly preferred that rotation of the cam lever urges the second end of the slider across the cam surface on the cam base.

In preferred arrangements, the slider is retained within the cam lever, but not connected thereto.

It is preferred that the cam lever is rotatable on the cam base between first and second positions, and the cam unit comprises means to urge the cam lever from the second position to a position intermediate the first and second positions. In use, the means to urge the cam lever to the intermediate position is operable to do so only when there is on other force acting on the cam lever.

Preferably, the means to urge comprises a resilient arm. It is further preferred that the resilient arm is mounted on the cam lever and is operable to press against the cam base in the second position. In a variant arrangement, the means to urge may be disposed between the cam lever and the cam follower. Typically, the means to urge is a resilient arm, that is preferably mounted on the cam follower. However, it is envisaged that it may be mounted on the cam lever.

In particularly preferred arrangements, an angle created between the second position and the intermediate position is approximately 5° to 25°.

According to a second embodiment of the present invention, there is provided a drawer unit comprising at least two drawers, each drawer comprising drawer runners to allow each drawer to move with respect to the drawer unit to open and close, the drawer unit comprising a lock mechanism to permit opening of only one drawer at a time, the lock mechanism comprising: a cam unit with a cam lever rotatably mounted thereon, cam follower, and a slider operable to slide with respect to the cam unit on rotation of the cam lever and engage with the cam follower, and a compression means, wherein movement of the cam follower and/or the cam unit is operable to compress the compression means and lock movement of the other drawer.

Preferably the slider engages with a camming surface, whereby, for at least the initial opening of the first drawer, the camming surface has increasing eccentricity. It is particularly preferred that the camming surface has continuously increasing eccentricity.

The slider may be fabricated from a material with low friction characteristics. Options include plastic, Teflon, or the like.

It is preferred that the cam follower comprises a slanted camming surface. Such an arrangement is advantageous in that a lower initial force is required to open the drawer. The slant is preferably between 15° and 25°, with 20° being particularly preferred.

According to a further aspect of the present invention, there is provided a drawer unit comprising at least two drawers, each drawer comprising respective drawer runners to allow each drawer to move with respect to the drawer unit so as to open and close, the drawer unit further comprising a drawer lock mechanism to permit the opening of a single drawer at a time in said drawer unit, said lock mechanism comprising a cam unit incorporating at least a cam lever, and a cam follower comprising a surface operable to engage with said cam lever associated with each drawer, wherein the cam lever is operable to be rotated by action of the opening of its respective drawer, and engage with said cam follower, wherein movement of the cam follower and/or the cam unit causes compression of one or more compression means, wherein the cam lever is operable to move position between a first limit and a second limit, and wherein the cam unit comprises means to urge the cam lever from the second limit to a position intermediate the first limit and the second limit.

Preferably, the means to urge comprises a resilient arm located on the cam lever. However, the means to urge may be located between the cam follower and the cam lever, with the means to urge typically mounted on the cam follower.

Such an arrangement is advantageous in that it ensures that, when a drawer has been removed, the locking mechanism is reset so as to be able to engage with a drawer when said drawer is re-inserted, without the need for a user to manually reset the locking mechanism.

It is preferred that the drawer runner, directly or indirectly, activates the cam lever. Means may be mounted on the drawer runner to engage with the cam lever.

Preferably the lock mechanism comprises means to prevent any drawer being opened. Typically, such an arrangement would be activated by a key.

In order that the present invention be more readily understood, specific embodiments will now be described with reference to the accompanying drawings.

### BRIEF DESCRIPTION OF THE DRAWINGS

FIG. 1 shows an example of a drawer unit.

FIG. 2 shows an example of the drawer unit of FIG. 1 with a single drawer partially open.

FIG. 3 shows a cross-section of an inner surface of a side wall of the drawer unit of FIGS. 1 and 2. In this arrangement two drawer runners are shown, both in the position of when both drawers are closed.

FIG. 4 shows the inner wall of FIG. 3, whereby one of the runners is in a partially open position.

FIG. 5 shows a lock mechanism in accordance with an embodiment of the present invention. Note that the lock mechanism is shown in situ in FIGS. 3 and 4.

FIG. 6 shows an exploded representation of the lock mechanism of FIG. 5.

FIG. 7 shows a cam base.

FIG. 8 shows a slider.

FIG. 9 shows a cam lever.

FIGS. 10-12 each show different stages of the operation of the lock mechanism of FIGS. 5 and 6.

FIGS. 13-15 each show a close up of different stages of the operation of the lock mechanism of FIGS. 5 and 6, and correspond, respectively, to FIGS. 10-12.

FIG. 16 shows a variant cam unit.

FIGS. 17 to 19 show the cam unit of FIG. 16 in different stages of operation. Specifically, FIG. 17 shows a drawer unit with a drawer open; FIG. 18 shows the drawer being removed from a cabinet, and FIG. 19 shows the drawer removed from the cabinet.

### DESCRIPTION OF PREFERRED EMBODIMENTS

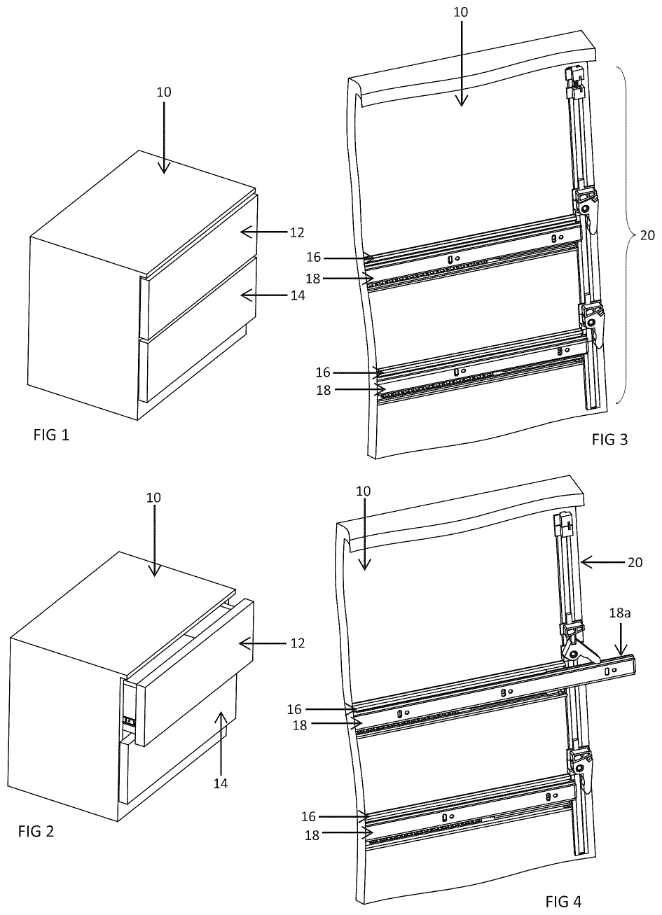

The present arrangement relates to a drawer unit. FIGS. 1 and 2 show an example drawer unit 10, with a first (upper) drawer 12 and a second (lower) drawer 14. The drawers 12, 14 are operable to slide in and out of the drawer unit 10 in a convention manner. The drawer unit 10 comprises drawer guides 16, and each drawer comprises drawer runners 18. This arrangement is shown in FIGS. 3 and 4, with the upper drawer runner 18a being shown in a partially open position in FIG. 4.

A unit with two drawers is shown for ease of reference. Any number of drawers could be provided.

A locking mechanism 20 is provided on at least one inner side wall of the drawer unit 10. An example is shown in FIGS. 3 and 4. It would be possible to provide a second locking mechanism on the opposite side of the drawer unit 10.

It is highly desirable to provide a drawer unit 10 that only permits one drawer to be opened at once. Such arrangement is advantageous in that it prevents the drawer unit 10 from tipping over and prevents injury to fingers (especially those of children) by stopping them getting trapped between two moving drawers.

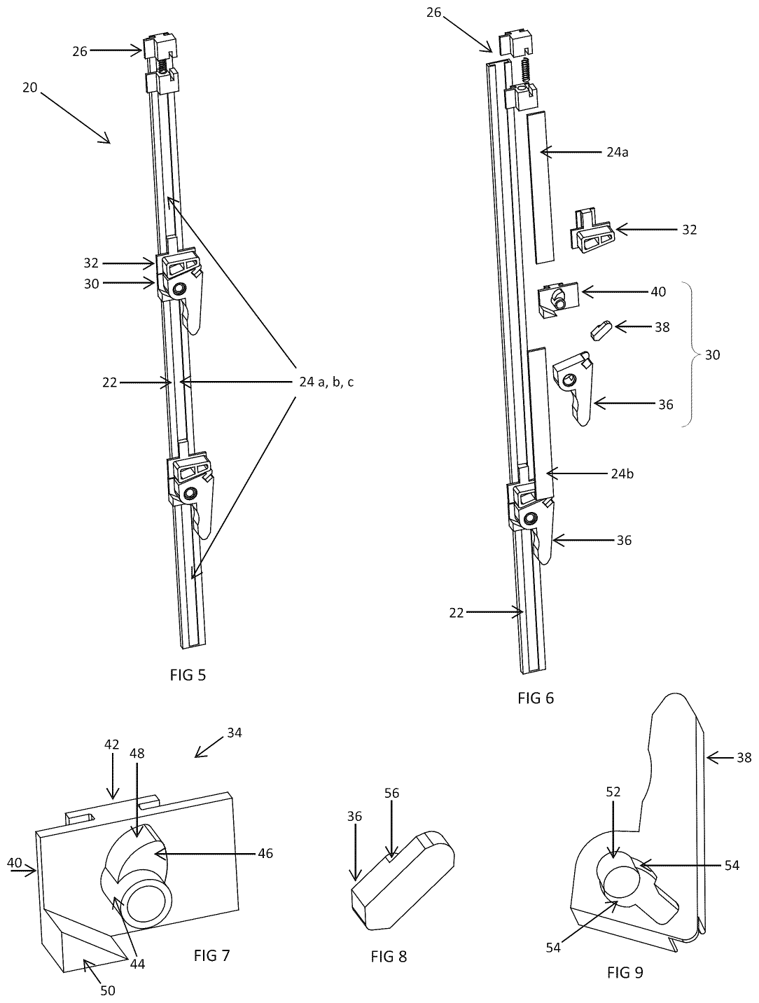

FIGS. 5 and 6 show a locking mechanism 20 for use with a drawer unit 10. The locking mechanism 20 comprises a guide rail 22 that is operable to be fixedly attached to the inside of the drawer unit 10, as shown in FIGS. 3 and 4.

Three bars 24a, 24b, 24c are positioned within the guide rail 22. In this arrangement at least the upper two bars 24a, 24b are slidably mounted in the guide rail 22.

A compression means 26 is provided at one end of the guide rail 22. In this case, the compression means 26 is located at the top of the guide rail 22 (when fitted into the drawer unit 10). However, it is equally desirable to place the compression means at the bottom of the guide rail 22.

Each drawer 12, 14, is associated with a cam unit 30 and a cam follower 32. One set of cam unit 30 and cam follower 32 is located between bars 24a and 24b (i.e., the upper and middle bars), and a second set of cam unit 30 and cam follower 32 is disposed between bars 24b and 24c (i.e., the middle and lower bars).

The cam followers are slidably mounted within the guide rail 22. The cam units are mounted on the guide rail 22.

The lock mechanism 20 may be fitted to the drawer until 10 during manufacture or may be retro-fitted thereto.

The sections of the cam unit 30 are shown in FIGS. 7 to 9. Specifically, FIG. 7 shows a cam base 34, FIG. 8 shows a slider 36 and FIG. 9 shows a cam lever 38.

The cam base 34 comprises a main body 40, with means 42 to allow it to be connected to the guide rail 22. Means 44 for mounting the cam lever 38 is provided. A cam profile 46, defining a camming surface 48 is further provided. The cam profile may be mounted on the mounting means 44, or the cam base 34, or both. A rotation stop block 50 is further provided.

Typically, the cam base 34, connection means 42, mounting means 44, cam profile 46, and stop block 50 are integrally fabricated.

FIG. 9 shows a cam lever 38. The cam lever 38 comprises a means 52 to engage with the mounting means 44 on the cam base 34. The mounting is such that the cam lever is operable to rotate with respect to the cam base 34. Rotation is both facilitated and limited by the stop block 50 on the cam base 34. The cam lever 38 defines a recess operable to house the slider 36. The edges 54 of the recess define the limit of movement of the cam lever 38 via engagement with the camming surface 48.

FIG. 8 shows the slider 36. The slider 36 is operable to fit within the recess of the cam lever 38 and move reciprocally with respect to said cam lever. The slider comprises a stepped portion 56 to limit movement.

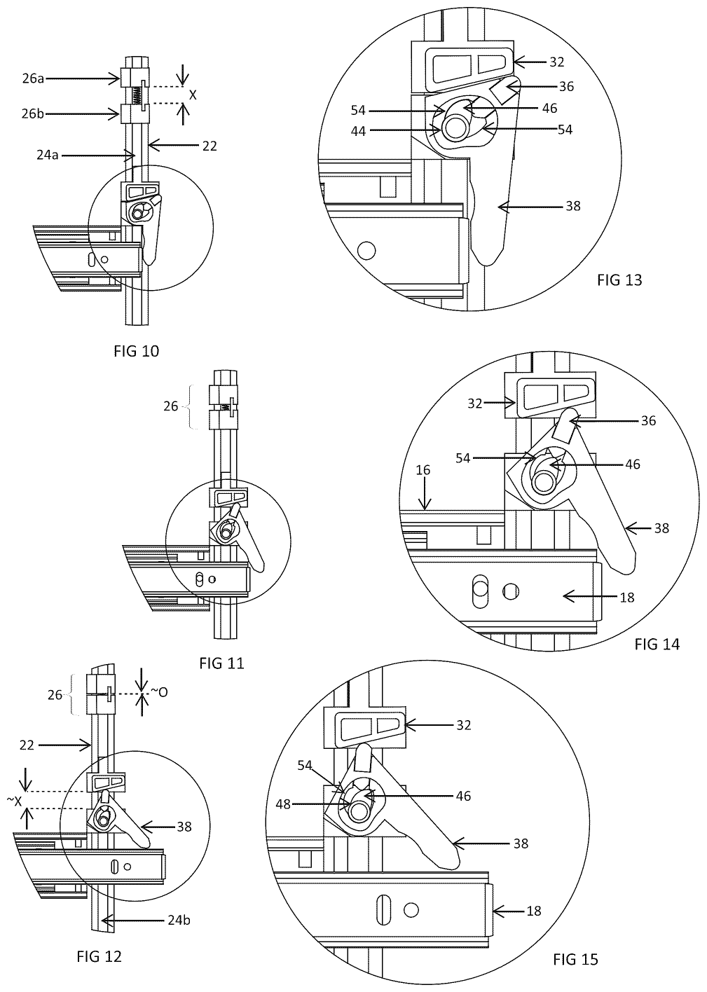

The operation of the arrangement will now be described with reference to FIGS. 10 to 15.

FIGS. 13 to 15 show a close-up of a drawer runner 18 engaging with a cam lever 38. In FIG. 13 the drawer is closed. FIG. 14 shows the drawer open a small amount, such the cam lever 38 has been engaged by the runner 18 and rotated by a small amount. FIG. 15 shows the drawer in a more open position. Here, the cam lever 38 has been rotated to its maximum extent.

The slider 36 is forced across the camming surface 48 located on the cam base 34. The edges 54 of the recess in the cam lever 38 limit rotation. As the drawer is opened the cam lever moves from a first position (FIG. 13) in which the left edge of the recess engages the left face of the camming profile, to a second position in which the right edge of the recess engages the right face of the camming profile. Such an action causes the slider 36 to ride along the right face of the camming profile (FIG. 13), reach the apex of the camming profile 46 (FIG. 14) and then travel along the left face of the camming profile 46 (FIG. 15). Such an action causes movement of the cam follower 32.

The cam follower has a slanted surface, typically between 15° and 25°, with 20° being particularly preferred. This arrangement reduces the initial force required from the user to begin opening of the drawer. The slider 36 passes over the apex of the cam profile 46, thus reducing the force required to continuing opening the drawer. These advantages work synergistically to provide a drawer with an easy-opening function to the user throughout its opening travel, but that locks further drawers from opening immediately.

FIGS. 10 to 12 shows the same action of cam unit 30 and cam follower 32 as in FIGS. 13 to 15. However, FIGS. 10 to 12 shows a more of the lock mechanism 20, including the compression means 26.

The compression means 26 comprises a fixed member 26a and a movable member 26b. When the drawers are closed, the moveable member 26b is spaced apart from the fixed member 26a. This spacing is shown in FIG. 10, indicated by the letter X. A compression spring 26c is located between the moveable member and the fixed member 26b.

The guide rail 22 houses bars 24a, b, c, the compression means 26 and the cam followers 32. The only free space is between the fixed member 26a and the moveable member 26b.

FIG. 11 shows a cam lever engaging a cam follower 32. The slider 36 is forcing the cam follower away from the cam unit 30. Such an action causes the moveable member to be urged towards the fixed member, thus compressing compression means 26, and thus reducing distance X. In FIG. 12, the cam lever 38 has been rotated by its maximum amount. The cam follower 32 is spaced at its furthest distance from the cam unit 30. This distance is effectively X. The compression means 26 is fully compressed, and the distance X between the fixed and movable pieces of the compression means is reduced to effectively zero. There is no more free space within the guiderail 22. Accordingly, it is not possible to open a further drawer; there is no space for the cam follower 32 of that drawer to move into.

It will be appreciated that the compression means may be located at the bottom of the lock mechanism. In this arrangement the cam follower may be held stationary, whilst the cam unit is urged towards the compression means.

In the case of two compression means, both the cam follower and the cam unit may move with respect to the drawer unit, such that both compression means are compressed.

It would be possible to incorporate a lock on the drawer to disable the locking mechanism 20, so as to be able to secure the drawer unit 10.

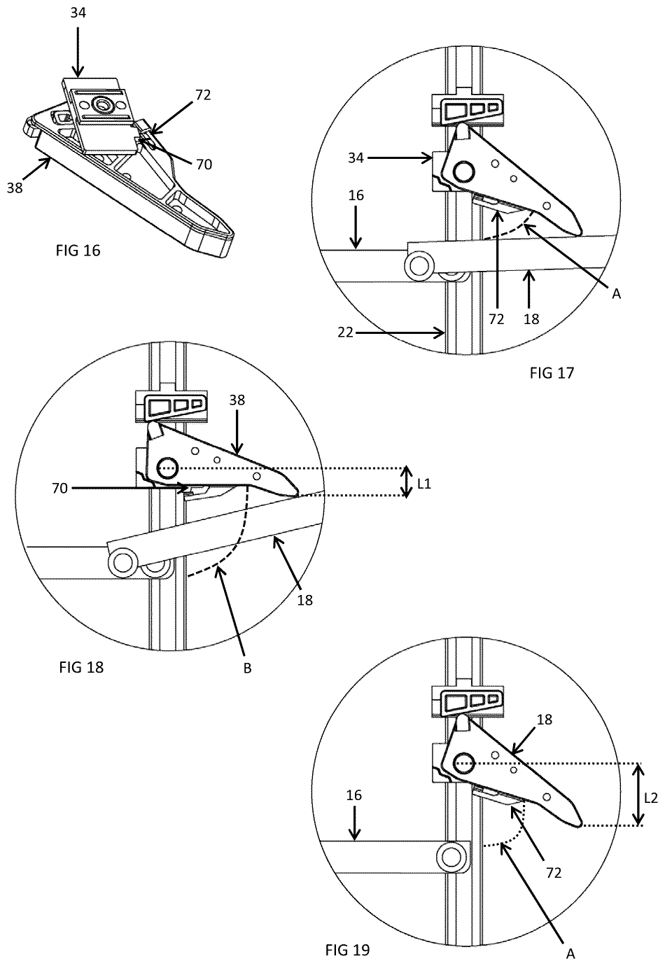

FIGS. 16 to 19 show a variant cam unit 30. The cam unit 30 comprises a cam lever 38, cam slider 36, and cam base 34 as other embodiments. The cam 34 comprises a protrusion 70. The cam lever 38 comprises a resilient arm 72.

When the drawer is closed, the cam unit 30 is orientated as in, e.g., FIGS. 10 and 13. FIG. 17 shows the drawer opened. Note that in this embodiment the drawer guides and drawer runners comprise wheels. Such an arrangement is known. The angle created—angle A in FIG. 17—between the guide rail and the cam lever 38 is typically 60°.

FIG. 18 shows the drawer being removed. As is known, it is typically required to tilt the drawer to remove it from the cabinet (drawer unit) 10. Accordingly, cam lever 38 is required to rotate further. The angle created between the guide rail 22 and the cam lever 38 may be approximately 90°. This is illustrated by angle B in FIG. 18. In this arrangement the protrusion 70 and the resilient arm 72 are urged together, bending the resilient arm 72 away from the cam lever 38. The force of the drawer 12 being lifted upwards is sufficient to overcome the resilience of the resilient arm 72.

FIG. 19 shows the cabinet 10 and lock mechanism 20 with the drawer 12 removed. As the drawer 12 is no longer urging the cam lever 38 upwards, the resilient arm 72 presses against the protrusion 70 to cause the cam lever 38 to revert back to the position in FIG. 17. Accordingly, the angle created between the guide rail and the cam lever 38 reverts to Angle A. This action is important, as it ensures that the drawer 12 can be replaced in the cabinet 10 without having to manually reset the cam lever 38. If the cam lever 38 retained Angle B, the drawer 12 would not be able to engage with the cam lever 38 correctly when being shut.

The above can be considered another way. FIGS. 18 and 19 also show two notional distances, L1 and L2, respectively. The off-centre distance L1 is too small to allow a smooth closure of the drawer 12 via interaction with the drawer's front panel. Distance L2 is greater than L1, and hence facilitates drawer closure.

In a variant embodiment, the resilient arm 72 may be mounted on the cam follower 32. In this arrangement, the resilient arm would project from the left end of the cam follower 32 as shown in the drawings (i.e. the thicker end of the cam follower). This arrangement would cause the same action as the above embodiment. Once the drawer is removed from the cabinet, the resilient arm would cause the cam lever 38 to rotate clockwise, as shown in, for example, FIGS. 17 to 19. This action ensures that the drawer 12 can be replaced in the cabinet 10 without having to manually reset the cam lever 38.

During standard use, it is immediately apparent what is the top, and what is the bottom, of a drawer unit. Accordingly, the words top and bottom are to be construed accordingly.

It is to be understood that the above-described specific embodiments are provided to aid understanding, and that many modifications and variations are possible within the scope of the appended claims.

1. A drawer unit comprising at least two drawers, each drawer comprising respective drawer runners to allow each drawer to move with respect to the drawer unit so as to open and close, the drawer unit further comprising a drawer lock mechanism to permit the opening of a single drawer at a time in said drawer unit, said lock mechanism comprising a cam unit incorporating at least a cam lever, and a cam follower comprising a surface operable to engage with said cam lever associated with each drawer, wherein the cam lever is operable to be rotated by action of the opening of its respective drawer, and engage with said cam follower, wherein movement of the cam follower and/or the cam unit causes compression of one or more compression means, and wherein the surface of the cam follower operable to engage with said cam lever is slanted when the drawer unit is in standard orientation at an angle of 15° to 25°.

2. A drawer unit according to claim 1, wherein the cam lever comprises a slider operable to reciprocally move substantially within the cam lever, a first end of the slider engaging said cam follower.

3. A drawer unit according to claim 2, wherein the cam unit comprises a cam base, with said cam lever being rotatably mounted thereon.

4. A drawer unit according to claim 3, wherein the cam unit comprises a cam surface operable to engage with a second end of said slider.

5. A drawer unit according to claim 4, wherein the cam surface has a continuously increasing eccentricity for at least a significant section thereof.

6. A drawer unit according to claim 5, wherein the cam surface has a first portion with a continuously increasing eccentricity and a second portion with a continuously decreasing eccentricity.

7. A drawer unit according to claim 4, wherein rotation of the cam lever urges the slider across the cam surface on the cam base.

8. A drawer unit according to claim 4, wherein the slider is retained within the cam lever, but not connected thereto.

9. A drawer unit according to claim 3, wherein the cam lever is rotatable on the cam base between first and second positions, and the cam unit comprises means to urge the cam lever from the second position to a position intermediate the first and second positions.

10. A drawer unit according to claim 9, wherein the means to urge comprises a resilient arm.

11. A drawer unit according to claim 10, wherein the resilient arm is mounted on the cam lever, and is operable to press against the cam base in the second position.

12. A drawer unit according to claim 11, wherein an angle created between the second position and the intermediate position is approximately 5° to 25°.

13. A drawer unit comprising at least two drawers, each drawer comprising drawer runners to allow each drawer to move with respect to the drawer unit to open and close, the drawer unit comprising a lock mechanism to permit opening of only one drawer at a time, the lock mechanism comprising: a cam unit with a cam lever rotatably mounted thereon, cam follower, and a slider operable to slide with respect to the cam unit on rotation of the cam lever and engage with the cam follower, and a compression means, wherein movement of the cam follower and/or the cam unit is operable to compress the compression means and lock movement of the other drawer.

14. A drawer unit according to claim 13, wherein the slider engages with a camming surface, whereby, for at least the initial opening of the first drawer, the camming surface has increasing eccentricity.

15. A drawer unit according to claim 14, wherein the camming surface has continuously increasing eccentricity.

16. A drawer unit according to claim 15, wherein the cam surface has a first portion with a continuously increasing eccentricity and a second portion with a continuously decreasing eccentricity.

17. A drawer unit according to claims 13, wherein the cam follower comprises a slanted cam surface.

18. A drawer unit according to claim 13, wherein the slant is 15° to 25°.

19. A drawer unit comprising at least two drawers, each drawer comprising respective drawer runners to allow each drawer to move with respect to the drawer unit so as to open and close, the drawer unit further comprising a drawer lock mechanism to permit the opening of a single drawer at a time in said drawer unit, said lock mechanism comprising a cam unit incorporating at least a cam lever, and a cam follower comprising a surface operable to engage with said cam lever associated with each drawer, wherein the cam lever is operable to be rotated by action of the opening of its respective drawer, and engage with said cam follower, wherein movement of the cam follower and/or the cam unit causes compression of one or more compression means, wherein the cam lever is operable to move position between a first limit and a second limit, and wherein the cam unit comprises means to urge the cam lever from the second limit to a position intermediate the first limit and the second limit.

20. A drawer unit according to claim 19, wherein the means to urge comprises a resilient arm located on the cam lever.

21. A drawer unit according to claim 1, wherein the drawer runner, directly or indirectly, activates the cam lever.

22. A drawer unit according to claim 1, wherein the lock mechanism comprises means to prevent any drawer being opened.
